(19) United States
(12) Patent Application Publication
(10) Pub. No.: US 2006/0188217 A1
(43) Pub. Date: Aug. 24, 2006

(54) Video recorder-player and playing method for the same

(76) Inventors: Kazunori Iwabuchi, Yokohama (JP); Kouji Kamogawa, Yokohama (JP); Keita Itoh, Yokohama (JP); Mitoshi Yajima, Ebina (JP)

Correspondence Address: MCDERMOTT WILL & EMERY LLP, 600 13TH STREET, N.W., WASHINGTON, DC, 20005-3096, US

(21) Appl. No.: 11/345,657

(22) Filed: Feb. 2, 2006

(30) Foreign Application Priority Data
Feb. 2, 2005 (JP) 2005-026580

(51) Int. Cl. H04N 5/91

(52) U.S. Cl. 386/68; 386/83

(57) ABSTRACT

A recording/playback system in which a recording file is stored in a storage through a recording operation or a pre-programmed recording operation includes a summary information generating unit that generates summary playback information of the recording file at the time of recording through the recording operation or the pre-programmed recording operation and causes the summary playback information to be stored in the storage, a summary playback button that makes an instruction for summary playback of the recording file based on the summary playback information, and an overall control unit that switches between a normal playback state and a summary playback state upon an instruction from the summary playback button during normal playback that has started through a playback button that makes an instruction for playback of the recording file. With this, the recording/playback system is provided so as to allow an operation state to be smoothly switched between normal playback and summary playback without causing stress on an operation by a viewer (operator).

### CROSS-REFERENCE TO RELATED APPLICATION

The present application claims priority from Japanese patent application No. JP 2005-026580 filed on Feb. 2, 2005, the content of which is hereby incorporated by reference into this application.

### BACKGROUND OF THE INVENTION

Conventionally, in a recording/playback system for recording and playing back moving picture information sent through broadcasting, communication, or the like, for the purpose of achieving summary recording, information about the size of audio in a recording file has been used to retrieve information for extracting important scenes, thereby allowing so-called digest playback. An example of a system achieving such digest playback is disclosed in Japanese Patent Laid-Open Publication No. 2002-330390.

### SUMMARY OF THE INVENTION

According to the technology disclosed in Japanese Patent Laid-Open Publication No. 2002-330390, an effect can be achieved in which the information indicating only the important scenes in a long program is extracted to allow a recording file to be played back in a short period of time. However, no consideration has been made to a method of making an instruction for normal playback according to a viewer's (operator's) preference during summary playback without summarizing recorded information, or a method of achieving such normal playback.

Moreover, no consideration has been made to a method of making an instruction for transition to summary playback during normal playback, or a method of achieving such transition.

Still further, no consideration has been made to a method of achieving an improvement in usability, the improvement allowing summary playback while a recording file is played back for viewing in a time-shifted manner during recording.

An object of the present invention is to provide a recording/playback system with a summary playback mechanism, the system allowing an operation state to be smoothly switched between normal playback and summary playback without causing stress on an operation by a viewer (operator).

A recording/playback system according to the present invention is a recording/playback system in which a recording file is stored in a storage through either one of a recording operation and a pre-programmed recording operation, the system comprising: summary information generating means that generates summary playback information of the recording file at the time of recording through either one of the recording operation and the pre-programmed recording operation and causes the summary playback information to be stored in the storage; summary playback operating means that makes an instruction for summary playback of the recording file based on the summary playback information; and overall control means that switches a normal playback state and a summary playback state upon an instruction from the summary playback operating means during normal playback that has started by playback operating means that makes an instruction for playback of the recording file.

According to the present invention, in order to switch between a normal playback state and a summary playback state, a playback button is pressed for transition to the normal playback state, and then a press of a summary playback button according to an operator's preference causes a transition to the summary playback state. Then again, another press of the summary playback button causes a return to the normal playback state. With such a very easy operation, it is possible to switch between the normal playback state and the summary playback state.

### DESCRIPTION OF THE DRAWINGS

FIG. 1 is a drawing of the configuration of a recording/playback system according to a first embodiment of the present invention;

FIG. 2 is an external view depicting the outer configuration of the recording/playback system according to the first embodiment of the present invention;

FIG. 3 is a drawing of the configuration of a remote controller of the recording/playback system according to the first embodiment of the present invention;

FIG. 4 is a drawing of the configuration of a front operation unit of the recording/playback system according to the first embodiment of the present invention;

FIG. 5 is a drawing of the storage configuration of a storage of the recording/playback system according to the first embodiment of the present invention;

FIG. 6 is a drawing of summary playback information generated at the time of execution of a pre-programmed recording function of the recording/playback system according to the first embodiment of the present invention;

FIG. 7 is a drawing of a pre-programmed recording setting screen displayed at the time of execution of the pre-programmed recording function of the recording/playback system according to the first embodiment of the present invention;

FIG. 8 is a flowchart of a control of a normal playback operation of the recording/playback system according to the first embodiment of the present invention;

FIG. 9 is a flowchart of a control at the time of an operation of switching between normal playback and summary playback in the recording/playback system according to the first embodiment of the present invention;

FIG. 10 is a drawing of a screen during normal playback in the recording/playback system according to the first embodiment of the present invention;

FIG. 11 is a drawing of a screen during summary playback in the recording/playback system according to the first embodiment of the present invention;

FIG. 12 is a drawing of the configuration of a remote controller of a recording/playback system according to a second embodiment of the present invention;

FIG. 13 is a flowchart of a control at the time of an operation of switching between normal playback and summary playback during recording playback in a recording/playback system according to a third embodiment of the present invention;

FIG. 14 is a drawing of the configuration of a recording/playback system according to a fourth embodiment of the present invention; and

FIG. 15 is a drawing of the configuration of a recording/playback system according to a fifth embodiment of the present invention.

### DESCRIPTION OF THE PREFERRED EMBODIMENTS

Embodiments of the present invention are described more precisely hereinafter referring to the drawings. Here, in all of the drawings for describing the embodiments, same reference numbers are used for denoting same components and repeated description will be omitted.

(First Embodiment)

<Configuration of the Recording/Playback System>

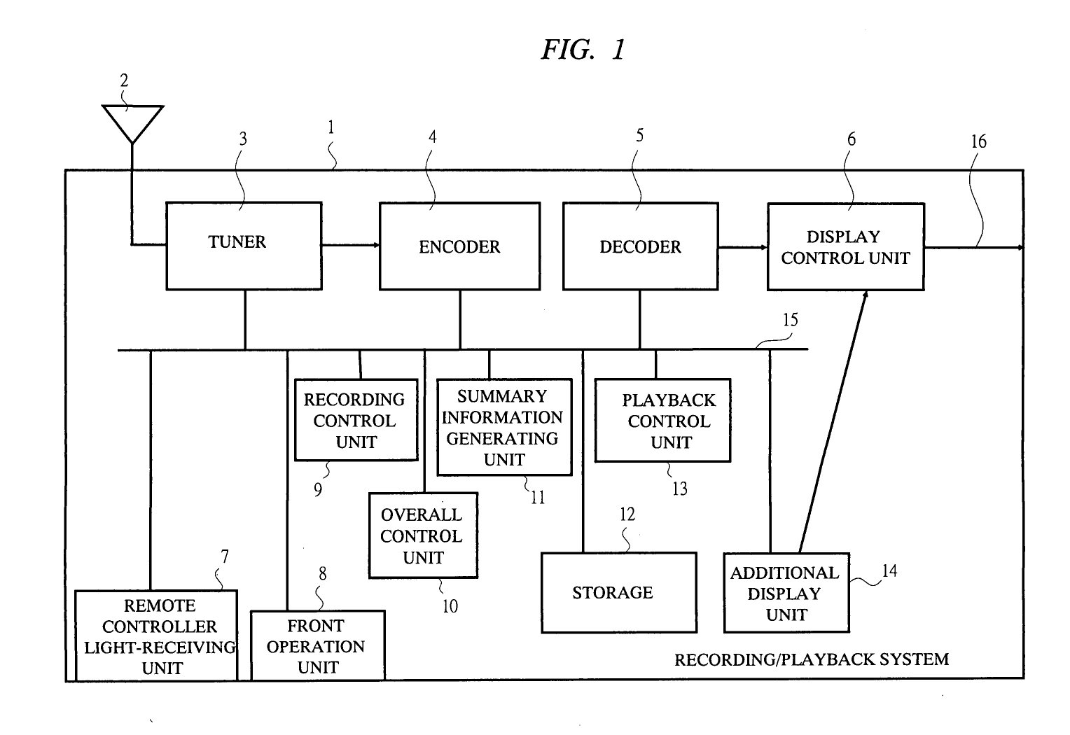

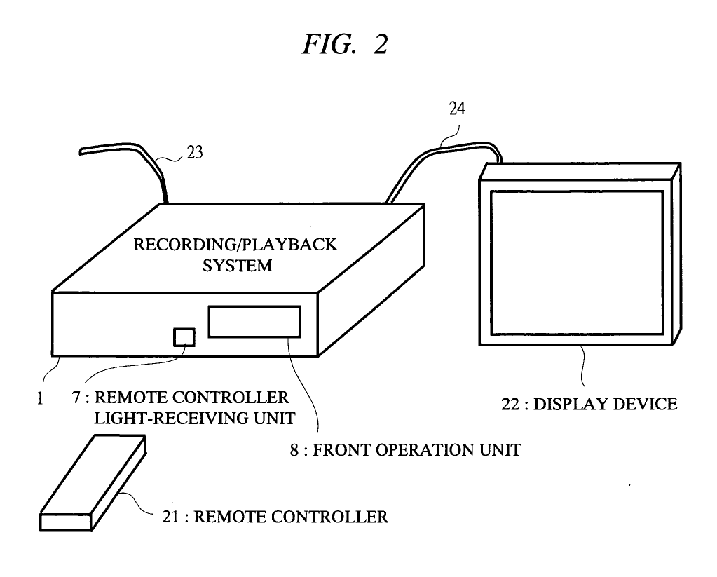

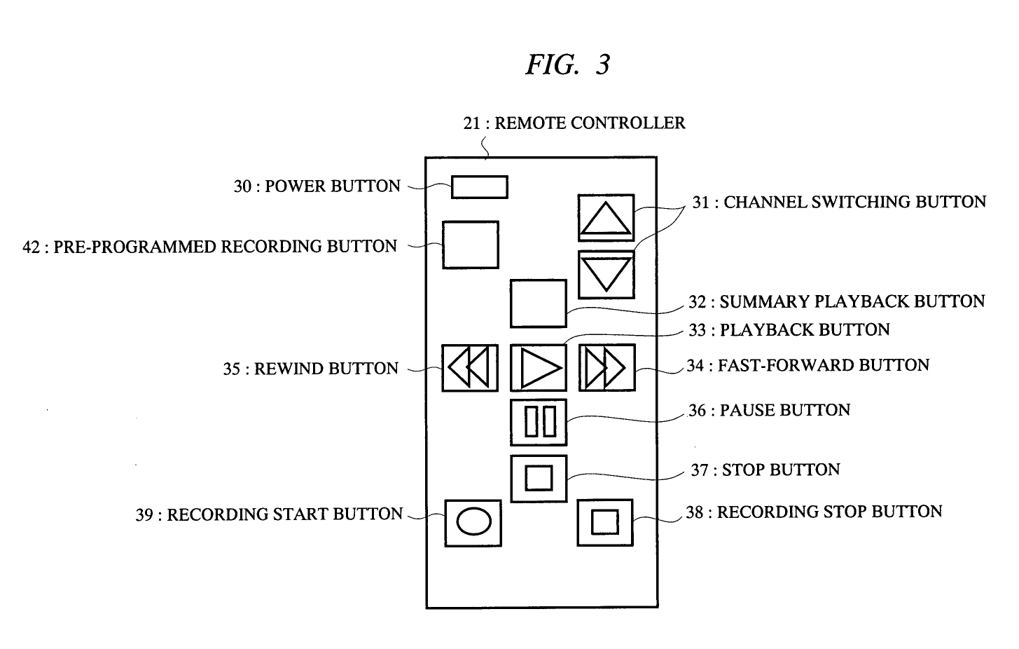

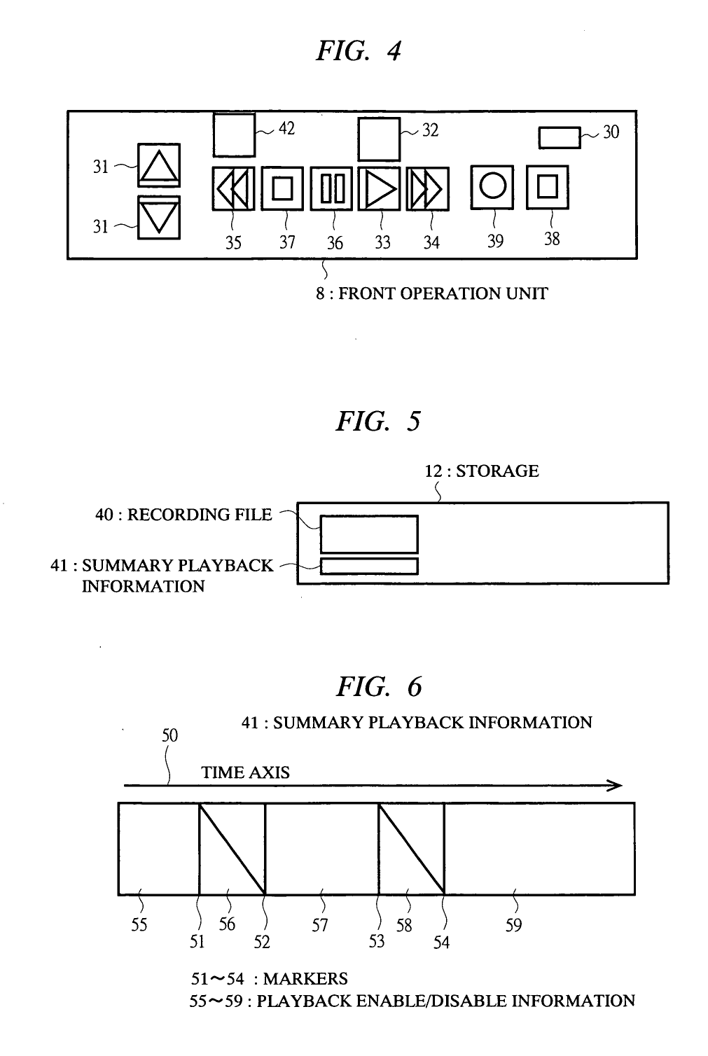

With reference to FIGS. 1 to 5, the configuration of a recording/playback system according to the first embodiment of the present invention is described. FIGS. 1 to 5 are drawings showing the configuration of the recording/playback system according to the first embodiment of the present invention, in which FIG. 1 is a drawing of the configuration of a recording/playback system according to a first embodiment of the present invention, FIG. 2 is an external view depicting the outer configuration of the recording/playback system according to the first embodiment of the present invention, FIG. 3 is a drawing of the configuration of a remote controller of the recording/playback system according to the first embodiment of the present invention, FIG. 4 is a drawing of the configuration of a front operation unit of the recording/playback system according to the first embodiment of the present invention, and FIG. 5 is a drawing of the storage configuration of a storage of the recording/playback system according to the first embodiment of the present invention.

In FIG. 1, a recording/playback system 1 includes an antenna 2, a tuner 3, an encoder 4, a decoder 5, a display control unit 6, a remote controller light-receiving unit 7, a front operation unit 8, a recording control unit 9, an overall control unit 10 serving as overall control means, a summary information generating unit 11 serving as summary generating means, a storage 12, a playback control unit 13, an additional display unit 14, and a system bus 15, wherein a video signal 16 is output from the display control unit 6.

In FIG. 2, the recording/playback system 1 includes a remote controller 21, and has connected thereto a display device 22 via a video cable 24, and the antenna 2 via an antenna cable 23.

In FIGS. 3 and 4, the remote controller 21 and the front operation unit 8 are each provided with a power button 30, channel switching buttons 31, a summary playback button 32 serving as summary playback operating means, a playback button 33 serving as playback operating means, a fast-forward button 34, a rewind button 35, a pause button 36, a stop button 37, a recording stop button 38, a recording start button 39, and a pre-programmed recording button 42.

Also, a user operation through the remote controller 21 is transferred to the recording/playback system 1 through the remote controller light-receiving unit 7, whilst a user operation through the front operation unit 8 is transferred to the recording/playback system 1 directly from the front operation unit 8. Furthermore, the video signal 16 output from the display control unit 6 of the recording/playback system 1 is transferred to the display device 22 through the video cable 24, and is then displayed as moving picture on the display device 22.

In FIG. 5, the storage 12 of the recording/playback system 1 has stored therein, in addition to a recording file 40, summary playback information 41 for summary playback of the recording file 40.

<Pre-programmed Recording Function and Playback Function of the Recording/Playback System>

Next, with reference to FIGS. 1 to 5, a recording function and a playback function of the recording/playback system according to a first embodiment of the present invention are described.

First, the overall control unit 10 receives a channel selection or a recording start operation through an operation from the remote controller 21 via the remote controller light-receiving unit 7 or through an operation of the front operation unit 8. Selection of a television broadcasting channel is achieved by the channel switching button 31 on the remote controller 21 shown in FIG. 3 or the channel switching button 31 on the front operation unit 8 shown in FIG. 4, and an instruction for a recording start operation is achieved by the operator with the recording start button 39.

The overall control unit 10 instructs the tuner 3 for channel selection, thereby causing a television broadcasting channel received from the antenna 2 to be selected. The recording control unit 9 instructs the encoder 4 to start a moving picture compression process so as to start recording upon instruction from the overall control unit 10. An output from the encoder 4 is stored in the storage 12 as a recording file.

This recording file is stored inside of the storage 12, as shown in the recording file 40 of FIG. 5. When the recording file 40 is stored inside of the storage 12, the summary playback information 41 is generated by the summary information generating unit 11, and is stored inside of the storage 12 with the recording file 40 as a pair.

Also, when the operator operates the recording stop button 38 on the remote controller 21 or the recording stop button 38 on the front operation unit 8, such an operation instruction is transferred from the remote controller light-receiving unit 7 or the front operation unit 8 to the overall control unit 10.

Then, upon receiving the operation instruction, the overall control unit 10 instructs the recording control unit 9 as such, and the recording control unit 9 in turn instructs the encoder 4 to stop the moving picture compression process, thereby stopping storing in the recording file 40 in the storage 12. With the operation described above, the recording function of the recording/playback system 1 is achieved, thereby making it possible to receive and record television broadcasting.

As for the playback function of the recording/playback system 1, when the operator operates the playback button 33 on the remote controller 21 or the playback button 33 on the front operation unit 8, an operation instruction is transferred from the remote controller light-receiving unit 7 or the front operation unit 8 to the overall control unit 10.

The overall control unit 10 then instructs the playback control unit 13 to start playback. The playback control unit 13 sends the recording file 40 stored in the storage 12 to the decoder 5 for starting a moving image process. An output of the decoder 5 is output through display control unit 6 from the recording/playback system 1 as the video signal 16. With the operation described above, the playback function of the recording/playback system 1 is achieved, thereby making it possible to play back the recorded video of the recording file.

<Pre-programmed Recording Function of the Recording/Playback System>

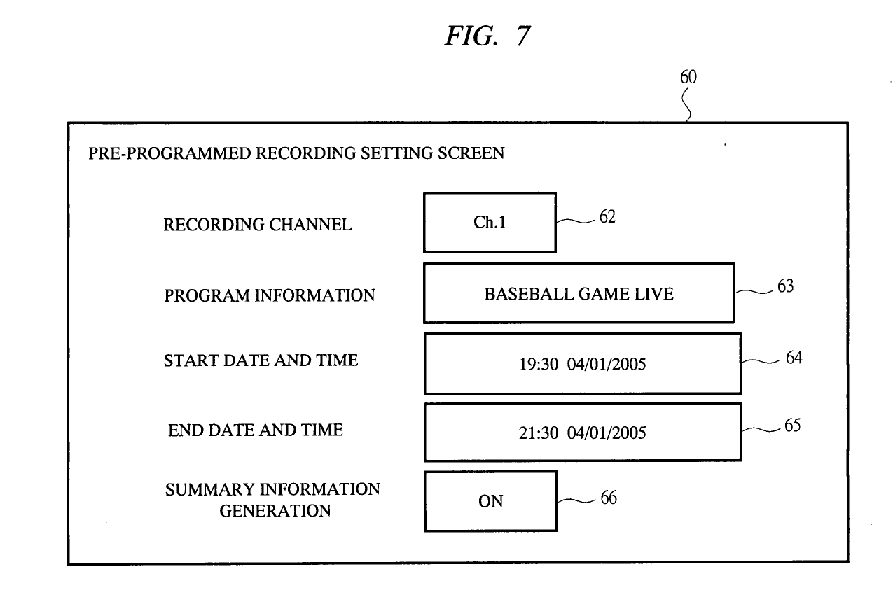

Next, with reference to FIGS. 6 to 7, a pre-programmed recording function of the recording/playback system according to a first embodiment of the present invention are described. FIG. 6 is a drawing of summary playback information generated at the time of execution of a pre-programmed recording function of the recording/playback system according to the first embodiment of the present invention, FIG. 7 is a drawing of a pre-programmed recording setting screen displayed at the time of execution of the pre-programmed recording function of the recording/playback system according to the first embodiment of the present invention.

In FIG. 6, information stored in the summary playback information 41 includes a time axis 50, markers 51 to 54, and playback enable/disable information 55 to 59.

Also, each piece of information in the summary playback information 41 is generated by the summary information generating unit 11 at the time of execution of the recording function by using a generation algorithm, such as a summary generation algorithm disclosed in, for example, Japanese Patent Laid-Open Publication No. 2004-304676, Japanese Patent Laid-Open Publication No. 2004-312567, or Japanese Patent Laid-Open Publication No. 2004-320092. The summary generation algorithm is not meant to be restricted to the above, but may be any algorithm as long as it can generate the summary playback information 41.

Furthermore, the summary playback information 41 generated by the summary information generating unit 11 is sectioned, as shown in FIG. 6, with the markers 51 to 54 along the time axis 50. Here, the playback enable/disable information 55 to 59 represent whether to play back portions sectioned with the markers 51 to 54. In the example shown in FIG. 6, the playback enable/disable information 56 and 58 each with a diagonal line being displayed represent portions that are playback-disabled, whilst the playback enable/disable information 55, 57, and 59 represent portions that are playback-enabled.

As such, the summary playback information 41 indicates important scenes and unimportant scenes, and serves as basic information for achieving summary playback in a short period of time by playing back only the important scenes without playback entirely.

Here, when summary playback is performed with the summary playback information 41, based on the playback enable/disable information 55 to 59, instead of skipping the playback-disabled portions and playing back only the playback-enabled portions, the playback-disabled portions may be played back fast forward.

In this case, the playback-disabled portions are played back, although fast forward, and therefore the entire portions can be viewed in summary without interrupting the entire flow.

Also, ranking can be set to the playback-enabled portions in accordance with the importance. When a summary playback time is specified, playback-enabled portions are selected, based on the summary playback time, in descending order of importance in ranking, and are regarded as summary information. With this, for example, depending on a varied summary playback time, such as ten minutes or thirty minutes for a one-hour program, optimum summary playback can be performed.

In FIG. 7, information displayed on a pre-programmed recording setting screen 60 includes a recording channel 62, program information 63, start date and time 64, end date and time 65, and summary information generation 66.

As the pre-programmed recording function of the recording/playback system 1, firstly, when the pre-programmed recording button 42 on the remote controller 21 shown in FIG. 3 or the pre-programmed recording button 42 on the front operation unit 8 shown in FIG. 4 is pressed through an operation by the user, the overall control unit 10 uses the additional display unit 14 to generate the pre-programmed recording setting screen 60 as shown in FIG. 7. Then, through the display control unit 6, the pre-programmed recording setting screen 60 is displayed on the display device 22.

In the example shown in FIG. 7, the information of the recording channel 62, the start date and time 64, the end date and time 65, and the summary information generation 66 can be corrected through the remote controller 21 or the front operation unit 8. The program information 63 can be obtained through electronic program schedule information acquired through a broadcast wave or the Internet.

The user operates the remote controller 21 or the front operation unit 8 to input information of a desired program for pre-programmed recording. Here, such an input of the pre-programmed recording information can also be made through selection from electronic program schedule information or the like.

Also, in the example shown in FIG. 7, when the summary information generation 66 is turned ON, the recording function is performed at the pre-programmed start date and time, simultaneously causing the summary information generating unit 11 to perform an operation to generate the summary playback information 41. Here, an initial value of the summary information generation 66 can be switched to ON or OFF depending on the information displayed on the program information 63. To change the initial value, the user operates the remote controller 21 or the front operation unit 8.

Furthermore, the summary playback information 41 generated at the time of pre-programmed recording of the program is stored, as shown in FIG. 5, in the storage 12 with the recorded recording file 40 as a pair.

<Internal Operations of the Overall Control Unit, the Recording Control Unit, and the Playback Control Unit in the Recording/Playback System>

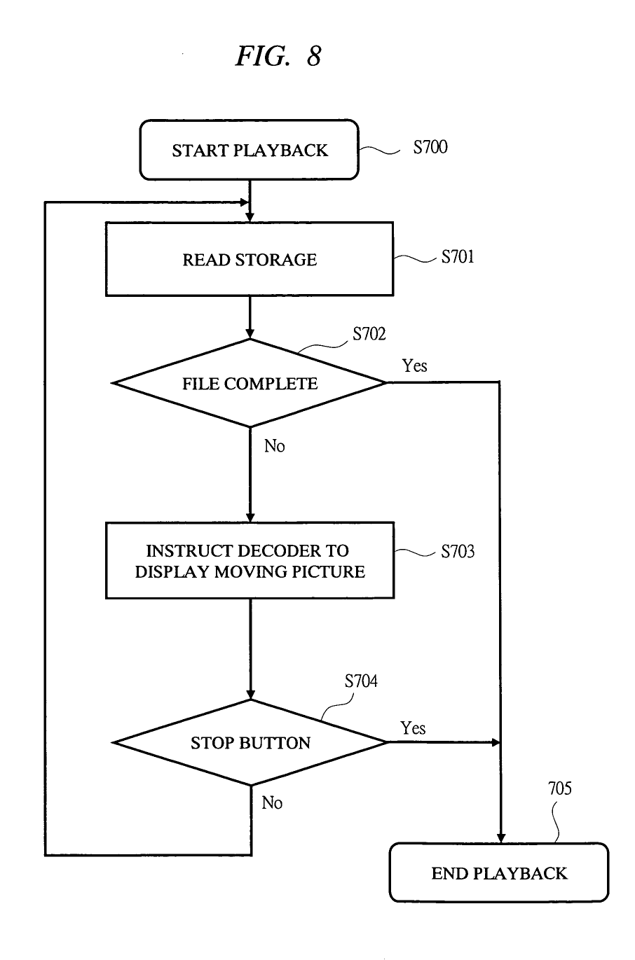

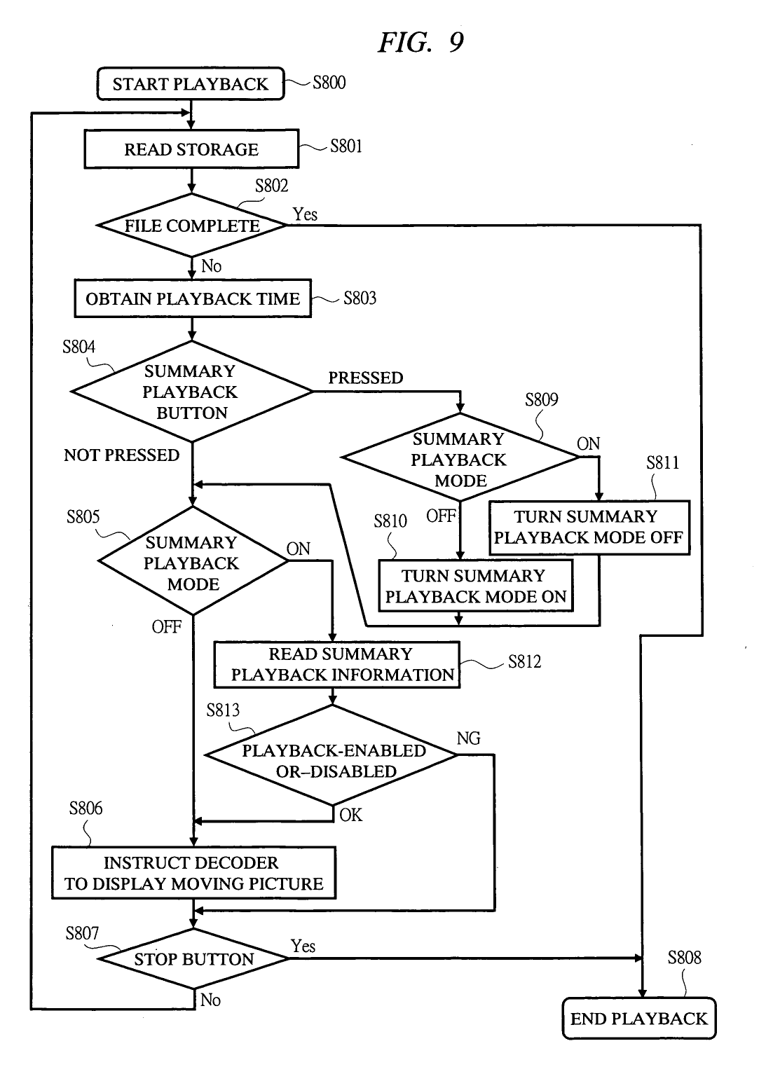

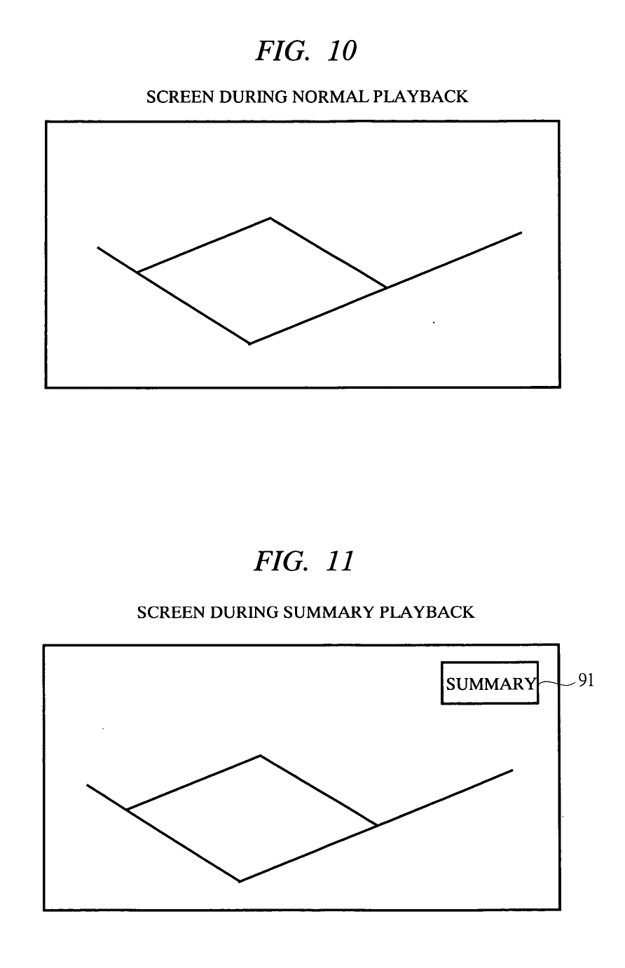

Next, with reference to FIGS. 8 to 11, internal operations of the overall control unit, the recording control unit, and the playback control unit in the recording/playback system according to the first embodiment of the present invention are described. FIGS. 8 to 11 are drawings for describing the internal operations of the overall control unit, the recording control unit, and the playback control unit in the recording/playback system according to the first embodiment of the present invention, in which FIG. 8 is a flowchart of a control of a normal playback operation, FIG. 9 is a flowchart of a control at the time of an operation of switching between normal playback and summary playback, FIG. 10 is a drawing of a screen during normal playback, FIG. 11 is a drawing of a screen during summary playback.

A control of a normal playback operation is performed such that, as shown in FIG. 8, firstly, when an instruction for a playback start is provided by using the remote controller 21 or the front operation unit 8, the procedure goes from S700 to S701 for reading the recording file 40 from the storage 12.

Next, the procedure goes to S702, wherein it is determined whether the recording file 40 has been completely read out to the end. If the state is in a file complete state in S702, the procedure goes to S705 to end playback. If the state is not in a file complete state in S702, the procedure goes from S702 to S703 for providing an instruction for a playback operation to the decoder 5.

Then, the procedure goes to S704. If the stop button 37 on the remote controller 21 has been pressed, the procedure goes to S705 to end the playback operation. If the stop button 37 has not been pressed in S704, the procedure returns to S701 to continue the playback operation. As a result of the operation, a normal playback control is performed.

A control at the time of an operation of switching between normal playback and summary playback is performed such that, as shown in FIG. 9, firstly, upon instruction for playback start by using the remote controller 21 or the front operation unit 8, the procedure goes from S800 to S801 for reading the recording file 40 from the storage 12.

Next, the procedure goes to S802, wherein it is determined whether the recording file 40 has been completely read out to the end. If the state is in a file complete state in S802, the procedure goes to S808 for ending playback.

On the other hand, if the state is not in a file complete state in S802, the procedure goes from S802 to S803 for obtaining a playback time from the recording file 40. This playback time is on a scale identical to that of the time axis 50 of the summary playback information 41 shown in FIG. 6, and is for later use at the time of a summary playback process.

Next, the procedure goes to S804. When the summary playback button 32 on the remote controller 21 or the front operation unit 8 is pressed, the procedure goes to S809. In S809, a current summary playback mode is checked. If the mode is ON, the procedure goes to S811 for turning the summary playback mode OFF.

On the other hand, if the summary playback mode is OFF in S809, the procedure goes to S810 for setting the summary playback mode ON.

The procedure then goes to S805 for checking the summary playback mode. If the summary playback mode is ON, the procedure goes to S812 for reading the summary playback information 41, then goes to S813 for evaluating the playback time obtained in the previous S803 and the summary playback information 41 to check whether portions are playback-enabled.

If playback is enabled in S813, the procedure goes to S806 for causing the decoder 5 to perform a moving picture extending operation for moving picture display, and then goes to S807.

On the other hand, if playback is disabled in S813, the procedure goes to S807 without moving picture display. When the stop button 37 on the remote controller 21 or the front operation unit 8 is pressed, the procedure goes to S808 to end the playback operation.

On the other hand, if the stop button 37 on the remote controller 21 or the front operation unit 8 is not pressed in S807, the procedure goes to S801 to continue the playback operation. As a result of the operation described above, every time the summary playback button 32 is pressed, switching between normal playback and summary playback operations can be made.

Also, as for moving picture display screens during normal playback and summary playback, video as shown in FIG. 10 is displayed on the display device 22 during normal playback. In a summary playback state with the operation as shown in FIG. 9, a pictogram 91 indicating that a summary is being played back is displayed, as shown in FIG. 11.

As a result of the operation described above, an effect can be achieved such that the operator can recognize whether the moving picture currently being displayed is in normal playback or summary playback.

Here, FIG. 11 depicts an example in which the pictogram is displayed on the display device. Such a pictogram may be displayed at an arbitrary position, may blink, and may have an arbitrary design as long as it is easy to understand. Also, instead of the pictogram 91, a character indicating that a summary is being played back or the like may be displayed. Also, such a pictogram, a character, or the like may be displayed not on the display device 22, but on the front surface of the recording/playback system 1 or on a display portion on the remote controller 21.

(Second Embodiment)

In a second embodiment, the summary playback button 32 according to the first embodiment is not provided on the remote controller 21, but the playback button 33 is used in place of a summary playback button.

<Configuration of the Remote Controller in the Recording/Playback System>

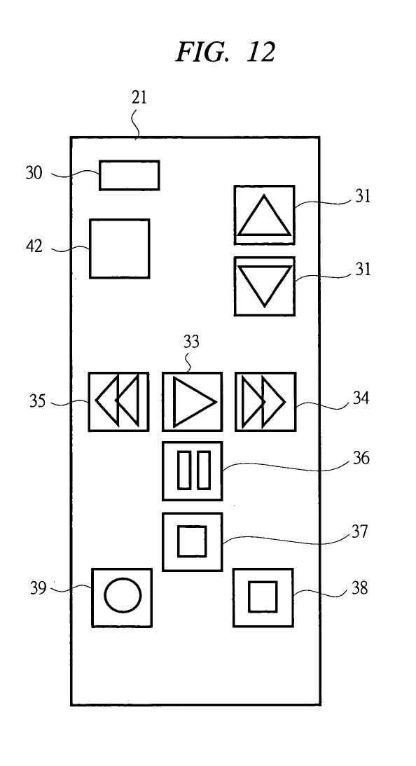

With reference to FIG. 12, the configuration of a remote controller in a recording/playback system according to the second embodiment of the present invention is described. FIG. 12 is a drawing of the configuration of the remote controller in the recording/playback system according to the second embodiment of the present invention.

In the first embodiment, the remote controller 21 shown in FIG. 3 is used. In the present embodiment, a remote controller 21 shown in FIG. 12 is used. A difference between the remote controller 21 shown in FIG. 3 and the remote controller 21 shown in FIG. 12 is whether a summary playback button 32 is present. The remote controller 21 shown in FIG. 12 does not have the summary playback button 32.

When the remote controller 21 shown in FIG. 12 is used, the playback button 33 plays a role as the summary playback button on the remote controller 21 shown in FIG. 3 during normal playback. In the present embodiment, with the playback button 33 being repeatedly pressed, switching between normal playback and summary playback can be made.

As for a control at the time of an operation of switching between normal playback and summary playback in the present embodiment, instead of determining in S804 of FIG. 9 that the summary playback button 32 has been pressed, only determining that the playback button 33 has been pressed is enough. In the present embodiment, switching between a normal playback state and a summary playback state can be made without adding a new button to the remote controller 21, thereby achieving an improvement in usability with a minimum number of components, and also achieving a convenient, seamless operation.

(Third Embodiment)

In a third embodiment, an operation of switching between normal playback and summary playback according to the first embodiment is performed during a recording function process.

<Control at the Time of Switching Between Normal Playback and Summary Playback During a Recording Function Process>

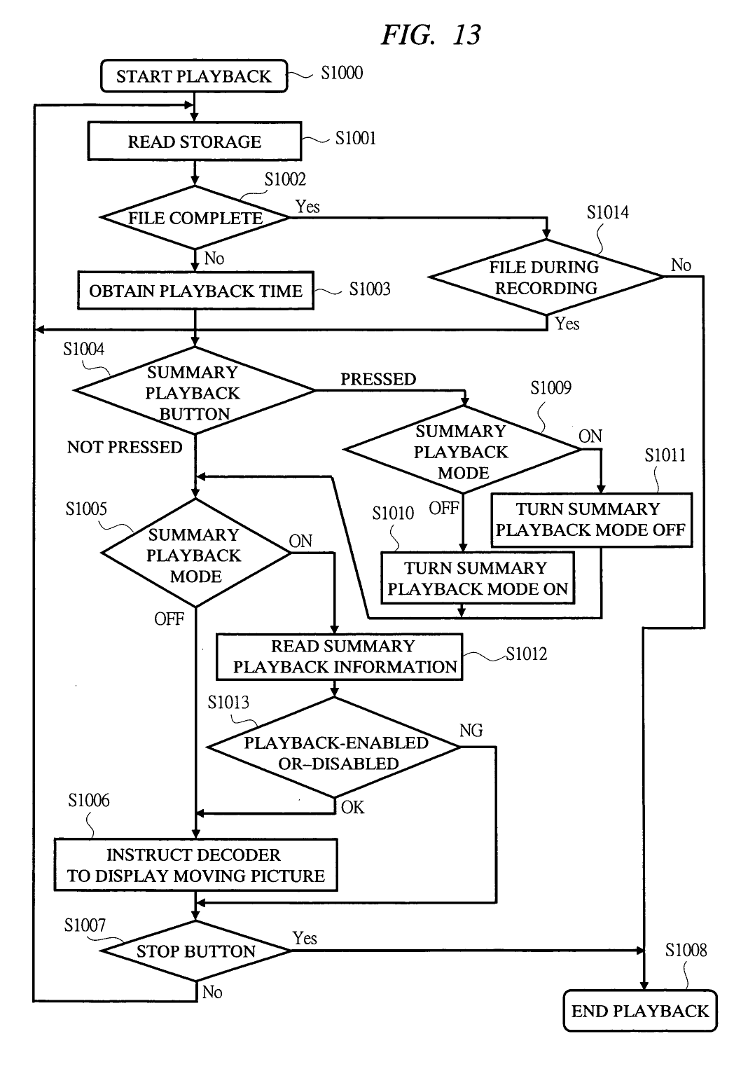

With reference to FIG. 13, the control at the time of switching between normal playback and summary playback during a recording function process according to the third embodiment of the present invention is described. FIG. 13 is a flowchart of a control at the time of an operation of switching between normal playback and summary playback during recording playback in a recording/playback system according to a third embodiment of the present invention.

As for a control at the time of an operation of switching between normal playback and summary playback during a recording function process, firstly, as shown in FIG. 13, upon instruction for playback start by using the remote controller 21 or the front operation unit 8, the procedure goes from S1000 to S1001 for reading the recording file 40 from the storage 12.

Next, the procedure goes to S1002, in which it is determined whether the recording file 40 has been completely read out to the end. If the state is in a file complete state in S1002, the procedure goes to S1014. In the case where a recording function process is being performed, the procedure goes to S1001 to continue the playback process.

If the recording function is not being performed in S1014, the procedure goes to S1008 to end the playback process.

If the state is not in a file complete state in S1002, the procedure goes from S1002 to S1003. Here, a control including and after S1003 is identical to the control including and after S803 shown in FIG. 9, and therefore its description is omitted herein.

As a result of the operation described above, in the playback operation during the recording function process, every time the summary playback button 32 is pressed, switching between normal playback and summary playback operations can be made.

Consequently, for example, in the case of a pre-programmed recording instruction as set on the pre-programmed recording setting screen 60 shown in FIG. 7, the start date and time 64 is set to be 19:30 on Apr. 1, 2005. At this time, recording starts without humans in attendance, and ends at 21:30 on Apr. 1, 2005 set in the end date and time 65. However, if the operator is just in time for the air time of the program, for example, if the operator is back home from the road by this end time, there is a possibility that the user may perform a playback operation.

In such cases, in accordance with an operator's preference, a summary playback state is caused to occur immediately after playback is started. This offers an effect of high convenience that makes it possible to catch up with real-time broadcast of the program with only the important scenes being viewed.

(Fourth Embodiment)

In a fourth embodiment, the overall control unit 10, the recording control unit 9, the summary information generating unit 11, and the playback control unit 13 according to the first embodiment are implemented by a CPU, ROM, and RAM.

<Configuration of the Recording/Playback System>

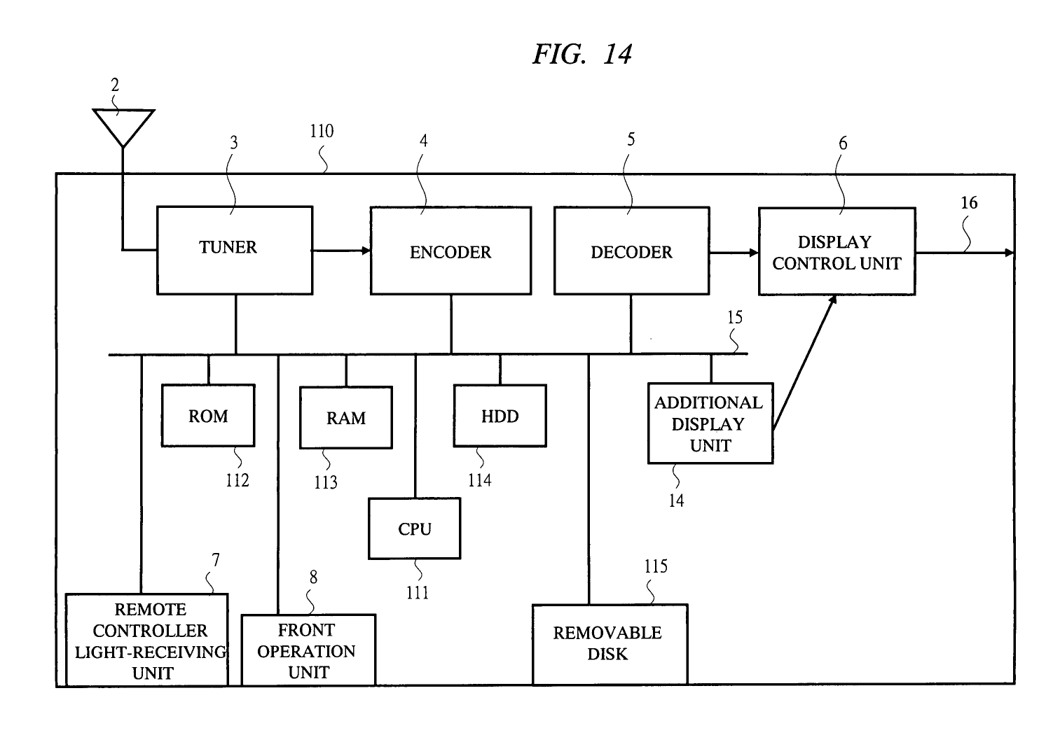

With reference to FIG. 14, the configuration of the recording/playback system according to the fourth embodiment of the present invention is described. FIG. 14 is a drawing of the configuration of a recording/playback system according to a fourth embodiment of the present invention.

In FIG. 14, the recording/playback system 110 includes a CPU 111, a ROM 112, a RAM 113, an HDD 114, and a removable disk 115. Other components are identical in configuration to those in the recording/playback system 1 shown in FIG. 1.

In FIG. 14, a difference between the recording/playback system 110 and the recording/playback system 1 shown in FIG. 1 is that the overall control unit 10, the recording control unit 9, the summary information generating unit 11, and the playback control unit 13 and their operations are implemented by the CPU 111, the ROM 112, and the RAM 113.

Also, the storage 12 is implemented by the HDD 114 and the removable disk 115.

This recording/playback system 110 is configured of general-purpose components, such as the CPU 111, the ROM 112, and the RAM 113, and has an effect of low manufacturing cost.

Also, in a recording/playback system, such as a personal computer or a DVD (Digital Versatile Disk) recorder, a summary playback function can be achieved.

Here, the type of the removable disk 115 is not meant to be restrictive, and various media can be used depending on the demands of the times and the degree of prevalence.

(Fifth Embodiment)

In a fifth embodiment, a digital tuner is used for receiving digital broadcasting in the fourth embodiment.

<Configuration of the Recording/Playback System>

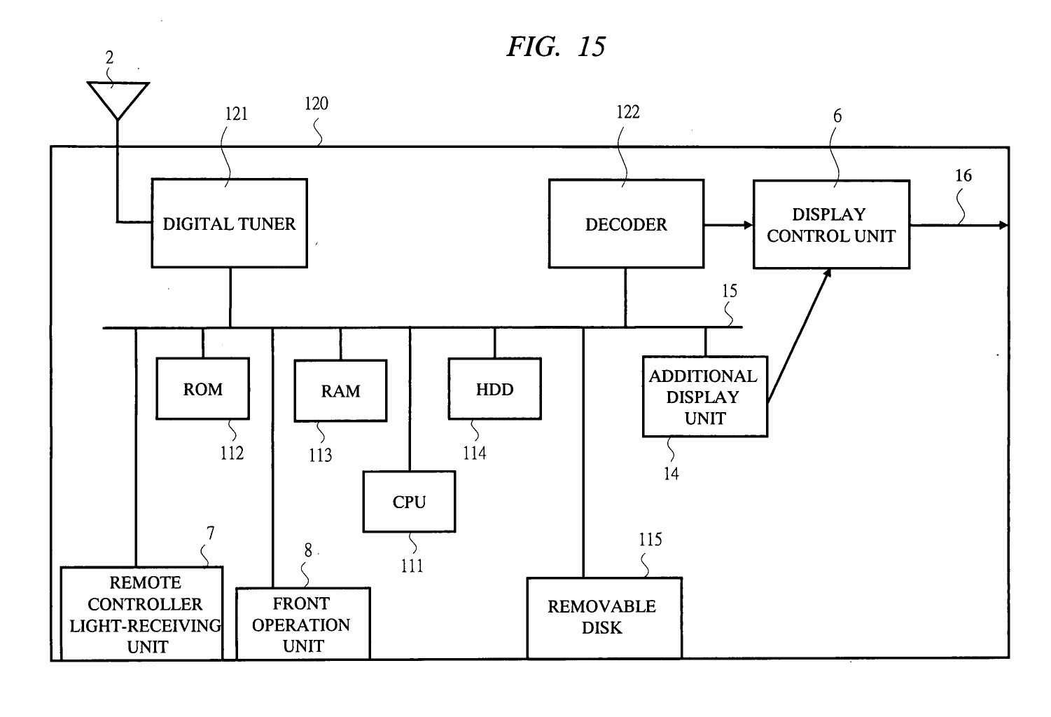

With reference to FIG. 15, the configuration of a recording/playback system according to the fifth embodiment of the present invention is described. FIG. 15 is a drawing of the configuration of the recording/playback system according to the fifth embodiment of the present invention.

In FIG. 15, a recording/playback system 120 includes a digital tuner 121, and a decoder 122. Other components are identical to those in the recording/playback system 110 shown in FIG. 14.

In FIG. 15, a difference between the recording/playback system 120 and the recording/playback system 110 shown in FIG. 14 is that the tuner 3 and the encoder 4 are replaced by the digital tuner 121 and that the decoder 5 is replaced by the decoder 122 supporting an output from the digital tuner.

In this recording/playback system 120, the digital tuner 121 is used for supporting digital broadcasting. Even the recording/playback system 120 supporting digital broadcasting can have a configuration in which switching can be easily made between a summary playback state and a normal playback state.

Also, a digital scheme may be supported by replacing the tuner 3 and the encoder 4 in the recording/playback system 1 shown in FIG. 1 by the digital tuner 121 and by replacing the decoder 5 in the recording/playback system 1 shown in FIG. 1 by the decoder 122 supporting an output from the digital tuner.

Although the present invention made by the present inventors is described above with reference to the preferred embodiments, it is needless to explain that the present invention is not limited to the above embodiments, and it is possible to modify them without departing the scope thereof.

What is claimed is:

1. A recording/playback system in which a recording file is stored in a storage through either one of a recording operation and a pre-programmed recording operation, the system comprising:
summary information generating means that generates summary playback information of the recording file at the time of recording through either one of the recording operation and the pre-programmed recording operation and causes the summary playback information to be stored in the storage;
summary playback operating means that makes an instruction for summary playback of the recording file based on the summary playback information; and
overall control means that switches a normal playback state and a summary playback state upon an instruction from the summary playback operating means during normal playback that has started by playback operating means that makes an instruction for playback of the recording file.

2. The recording/playback system according to claim 1, wherein
the overall control means switches between the normal playback state and the summary playback state for the recording file even during a recording operation through either one of the recording operation and the pre-programmed recording operation, based on the recording file during the recording operation and the summary playback information of the recording file during the recording operation.

3. The recording/playback system according to claim 1, wherein
the summary playback operating means is implemented through an operation by the playback operating means during the normal playback.

4. The recording/playback system according to claim 1, wherein
the overall control means causes either one of a character and a pictogram indicating that a summary is being played back to be displayed on a screen during summary playback in the summary playback state.

5. The recording/playback system according to claim 1, wherein
in the summary playback of the recording file based on the summary playback information, portions for the summary playback is played back based on the summary playback information, and portions not for the summary playback are either skipped or played back fast forward.

6. A recording/playback system in which video information sent through any one of broadcasting and communication is recorded on a recording device and the video information recorded in the recording device is played back, the system comprising:
operating means that makes an instruction for either one of a recording operation and a playback operation of the recording/playback system;
video recording means that records, upon an instruction for recording from the operating means, the video information on the recording device as a recording file;
summary information generating means that generates, upon the instruction for recording from the operating means, summary information of the video information and causes the summary information to be recorded on the recording device in association with the recording file;
playback mode storage means that stores a playback mode indicating either one of normal playback of the recording file upon a playback instruction from the operating means and playback of the recording file in accordance with the summary information; and
video playback means that plays back the recording file according to the playback mode set in the playback mode storage means.

7. The recording/playback system according to claim 6, wherein
the summary information includes information indicating, with a lapse of time, whether each scene is playback-enabled.

8. The recording/playback system according to claim 7, wherein
at a scene that is set in the summary information as being playback-disabled, the video playback means either skips playback of the recording file or plays back the recording file fast forward.

9. The recording/playback system according to claim 6, wherein
information in the playback mode storage means is switched in a manner such that the playback mode of the recording file is switched in accordance with a normal playback mode and the summary information through an operation of the operating means during playback of the recording file by the video playback means.

10. The recording/playback system according to claim 9, wherein
switching of the information in the playback mode storage means is performed upon each instruction for a playback operation to the operating means.

11. A recording/playback method for a recording/playback system in which video information sent through any one of broadcasting and communication is recorded on a recording device and the video information recorded in the recording device is played back, the method comprising the steps of:
making an instruction for either one of a recording operation and a playback operation of the recording/playback system;
recording, upon an instruction for recording, the video information on the recording device as a recording file;
generating, upon the instruction for recording, summary information indicating, with a lapse of time, whether the video information is playback-enabled, and causing the summary information to be recorded on the recording device in association with the recording file;
changing a playback mode indicating whether the recording file is to be normally played back or is to be played back in accordance with the summary information; and
playing back the recording file in accordance with the playback mode.

12. The recording/playback method for the recording/playback system according to claim 11, the method further comprising either one of steps of:
changing, upon an operation instruction during normal playback of the recording file, the playback mode to a mode for playing back the recording file in accordance with the summary information; and changing, upon an operation instruction during playback of the recording file in accordance with the summary information, the playback mode to normal playback.

13. The recording/playback method for the recording/playback system according to claim 11, wherein
in the playback mode for the recording file in accordance with the summary information, scenes of the video information that are set in the summary information as being playback-disabled are skipped.

14. The recording/playback method for the recording/playback system according to claim 11, wherein
in the playback mode for the recording file in accordance with the summary information, scenes of the video information that are set in the summary information as being playback-disabled are played back fast forward.
